(19) United States
(12) Patent Application Publication
(10) Pub. No.: US 2008/0104799 A1
(43) Pub. Date: May 8, 2008

(54) Non-Handed Adjustable Hinge Set

(76) Inventors: Christoph Hoppe, Mustair (CH); Elias Karnutsch, Nauders (IT); Oliver Erich Rudolf Schuberth, Laas (BZ) (DE); Ewald Eder, Schlanders (BZ) (IT)

Correspondence Address: REINHART BOERNER VAN DEUREN S.C.;ATTN: LINDA KASULKE, DOCKET COORDINATOR, 1000 NORTH WATER STREET, SUITE 2100, MILWAUKEE, WI, 53202, US

(21) Appl. No.: 11/935,564

(22) Filed: Nov. 6, 2007

Related U.S. Application Data
(60) Provisional application No. 60/864,494, filed on Nov. 6, 2006.
(60) Provisional application No. 60/884,794, filed on Jan. 12, 2007.

(51) Int. Cl. E05D 7/04

(52) U.S. Cl. 16/238

(57) ABSTRACT

An adjustable hinge for pivotally mounting a door on a door frame for pivoting of the door about a pivot axis relative to the frame for use in both left-handed and right-handed installations, includes a first adjustment mechanism located near one end of the hinge pin for providing vertical height adjustment in a left-handed installation and a second adjustment mechanism located near the opposite end of the hinge pin for providing vertical height adjustment in a right-handed installation set.

### CROSS-REFERENCE TO RELATED APPLICATIONS

This application claims priority benefit of U.S. Provisional Patent Application No. 60/864,494, which is entitled “Adjustable Hinge Set,” and which was filed on Nov. 6, 2006, and U.S. Provisional Patent Application No. 60/884,794, which is also entitled “Adjustable Hinge Set,” and which was filed on Jan. 12, 2007, the entirety of which applications are hereby incorporated herein by reference.

### BACKGROUND OF THE INVENTION

### Field of the Invention

The present invention relates to adjustable hinges for mounting a door on a frame, and, more particularly, to a non-handed adjustable hinge which is configured for use in both left-handed and right-handed installations.

Adjustable hinges are widely employed to adjust doors relative to frames so that the doors will be level and fit well within the frame. Adjustable hinges are known that allow two-way adjustment of the position of the door relative to the door frame, as exemplified by the adjustable hinges disclosed in U.S. Pat. Nos. 5,799,370, 5,701,636, 6,515,494, and 5,755,011. However, two-way adjustable hinges which are presently available generally are more complex, expensive and generally more difficult to install than conventional non-adjustable hinges. Moreover, adjustable hinges are sometimes difficult and often time-consuming to adjust because of the difficulty in manipulation of the adjustment mechanisms and the requirement for additional support for the door during adjustment.

The adjustable hinges disclosed in U.S. Pat. Nos. 5,799,370, 5,701,636, and 6,515,494 provide vertical adjustment by moving the hinge up and down on an adjustment axis. However, in the adjustable hinges disclosed in U.S. Pat. Nos. 5,799,370 and 5,701,636, the adjustment axis is offset with respect to the pivot axis for the hinge. Also, the mechanisms that provide the horizontal and vertical adjustments are contained within a common housing. Thus, for a three hinge set, when adjusting one hinge, the other two hinges must be released. In the hinge set disclosed in U.S. Pat. No. 5,799,370, the vertical adjustment mechanism is an integral part of the horizontal mechanism. Vertical adjustment is provided by rotating an eccentric cam in a slot on the door leaf to raise and lower the door leaf. Horizontal adjustment is provided by turning a horizontal adjustment screw that is located in the bracket to pivot the door leaf about a pivot point, which is not fixed. Similarly, in the hinge set disclosed in U.S. Pat. No. 5,701,636, the vertical adjustment screw is carried by the same component as the horizontal adjustment mechanism. Also, the pivot point for the horizontal adjustment mechanism is not fixed.

In the hinge set disclosed in U.S. Pat. No. 6,515,494, horizontal adjustment is provided by loosening a screw which rides in a horizontal slot, and manually sliding the hinge plate along the door jamb. The screw is tightened when the desired horizontal adjustment is obtained.

The hinge set disclosed in U.S. Pat. No. 5,755,011 has a vertical adjustment screw that is located coaxially with the pivot axis for the hinge. Vertical adjustment is made at the axis of the rotation of the door leaf with the vertical adjustment screw located at the pivot axis. However, the door leaf is common to both the vertical adjustment and the horizontal adjustment mechanisms and thus does not provide independent vertical and horizontal adjustments. The vertical adjustment screw moves the door leaf up and down with respect to the hinge. In addition, the horizontal adjustment mechanism, is a complicated mechanism including a central arch in the door leaf and tabs that ride in arcuate slots to change the spacing between the plate and the part housing as an adjustment is being made. Turning the horizontal adjustment screw causes the door leaf to pivot about a centrally located fulcrum.

It is accordingly the primary objective of the present invention that it provide an improved non-handed, adjustable hinge set designed to allow a door mounted in a door frame to be moved both up and down along a vertical axis and into and out of the door frame, along an axis orthogonal to the door frame.

Another objective of the present invention is that it provide a non-handed, adjustable hinge set including a set hinge and one or more guide hinges that are of simple construction, and in which the components of the guide hinges are identical with the components of the set hinge except for different threaded adjustment components for making horizontal and vertical adjustments.

Yet another objective of the present invention is that it provide a non-handed, adjustable hinge set that provides independent horizontal and vertical adjustments and is characterized by reduced manufacturing and assembly costs.

The non-handed, adjustable hinge set of the present invention must also be of construction which is both durable and long lasting, and it should also require little or no maintenance to be provided by the user throughout its operating lifetime. In order to enhance the market appeal of the adjustable hinge set of the present invention, it should also be of inexpensive construction to thereby afford it the broadest possible market. Finally, it is also an objective that all of the aforesaid advantages and objectives be achieved without incurring any substantial relative disadvantage.

### SUMMARY OF THE INVENTION

The disadvantages and limitations of the background art discussed above are overcome by the present invention. With this invention, there is provided an adjustable hinge for pivotally mounting a door on a door frame for pivoting of the door about a pivot axis relative to the frame. The adjustable hinge is configured for use in both left-handed and right-handed installations and adjustable hinge comprises a mounting member adapted to be secured to the door frame; an adjustable hinge assembly adapted to be secured to the door; and a hinge pin coupling together the adjustable hinge assembly and the mounting member, allowing pivoting of the door relative to the door frame about a pivot axis. The adjustable hinge assembly includes a vertical adjustment mechanism that is adjustable to reposition the door vertically. The vertical adjustment mechanism includes a first adjustment mechanism for providing vertical height adjustment in a left-handed installation and a second adjustment mechanism for providing vertical height adjustment in a right-handed installation set.

The first and second adjustment mechanisms each include an adjustment screw adapted to be coupled to the adjustment member, the position of said adjustment screws being adjustable vertically along a vertical axis to reposition the adjustment member vertically relative to the mounting member, thereby repositioning the door vertically. The adjustment screw of the first adjustment mechanism is located at one end of the hinge pin, and the adjustment screw of the second adjustment is located at the opposite end of the hinge pin.

The first adjustment mechanism further includes a first anti-rotation device received interposed between the first adjustment screw and a surface of the adjustment member, and the second adjustment mechanism further includes a second anti-rotation device interposed between the second adjustment screw and a surface of the adjustment member, the anti-rotation devices being indexed to the mounting plate to prevent the adjustment screws from rotating as the door is pivoted about the vertical axis.

In accordance with another aspect of the invention, there is provided an adjustable hinge for pivotally mounting a door on a stationary frame for pivoting of the door about a pivot axis relative to the frame, the adjustable hinge comprising a mounting member adapted to be secured to one of the door and the door frame. An adjustable hinge assembly is adapted to be secured to the other one of the door and the door frame. A hinge pin couples together the hinge assembly and the mounting member, allowing pivoting of the door relative to the door frame about a pivot axis. The hinge pin has an axial opening at first and second opposite ends. A first finial has a shank portion extending into the first axial opening and a head portion coupled to a first surface of the mounting member and a second finial has a shank portion extending into the second axial opening and a head portion coupled to a second surface of the mounting member, the first and second finials are held in place by a friction fit.

The adjustable hinge assembly further includes a first O-ring interposed between the head portion of the first finial and the first surface of the mounting member, and a second O-ring interposed between the head portion of the second finial and the second surface of the mounting member, enhancing the friction fit for the finials.

The head portion of the first finial includes a first annular groove receiving a portion of the first O-ring and the head portion of the second finial includes a second annular groove receiving a portion of the second O-ring. The first O-ring is trapped between an inner surface of the first groove and the first surface of the mounting plate and the second O-ring is trapped between an inner surface of the second groove and the second surface of the mounting plate.

It may therefore be seen that the present invention teaches an adjustable hinge set an adjustable hinge for pivotally mounting a door on a door frame for pivoting of the door about a pivot axis relative to the frame. The adjustable hinge is configured for use in both left-handed and right-handed installations and adjustable hinge comprises a mounting member adapted to be secured to the door frame; an adjustable hinge assembly adapted to be secured to the door; and a hinge pin coupling together the adjustable hinge assembly and the mounting member, allowing pivoting of the door relative to the door frame about a pivot axis. The adjustable hinge assembly includes a vertical adjustment mechanism that is adjustable to reposition the door vertically. The vertical adjustment mechanism includes a first adjustment mechanism for providing vertical height adjustment in a left-handed installation and a second adjustment mechanism for providing vertical height adjustment in a right-handed installation set.

The hinge pin can be a non-headed pin having an axial opening at first and second opposite ends, and first and second finials can have shank portions extending into axial openings at opposite ends of the hinge pin and held in place by friction fit. A pair of O-rings are interposed between the head portions of the finials and the mounting member, enhancing the friction fit for the finials.

The non-handed, adjustable hinge set of the present invention is of a construction which is both durable and long lasting, and which will require little or no maintenance to be provided by the user throughout its operating lifetime. The adjustable hinge set of the present invention is also of inexpensive construction to enhance its market appeal and to thereby afford it the broadest possible market. Finally, all of the aforesaid advantages and objectives are achieved without incurring any substantial relative disadvantage.

### DESCRIPTION OF THE DRAWINGS

These and other advantages of the present invention are best understood with reference to the drawings, in which:

FIG. 1 is a perspective view of a door and frame incorporating the adjustable hinge set in accordance with the present invention;

FIG. 2 is an isometric view of a set hinge of the adjustable hinge set of FIG. 1;

FIG. 3 is an exploded view of the set hinge of FIG. 2;

FIG. 4 is an isometric view of an assembly of a frame mounting plate and an adjustment plate of the set hinge of FIG. 2, shown with the adjustment screw removed;

FIG. 5 is a view of the set hinge of FIG. 2, partially in section to show the vertical height adjustment screw, and with the adjustment plate assembly in a centered position;

FIG. 6 is a plan view of a guide hinge of the hinge set of FIG. 1;

FIG. 7 is an exploded view of the guide hinge of FIG. 6;

FIG. 8 is an end view of a housing of the adjustment plate assembly of the guide hinge of FIG. 6;

FIG. 9 is a plan view of the inner surface of a housing front of the housing of FIG. 8;

FIG. 10 is a plan view of the outer surface of the housing front of the housing shown in FIG. 9;

FIG. 11 is a plan view of the inner surface of a housing back of the housing of FIG. 8;

FIG. 12 is a plan view of the outer surface of the housing back of the housing shown in FIG. 11;

FIG. 13 is a side view of an adjustment plate of the adjustable hinge plate assembly of the guide hinge of FIG. 6;

FIG. 14 is a plan view of one side of the adjustment plate of FIG. 13;

FIG. 15 is a plan view of the opposite side of the adjustment plate of FIG. 13;

FIG. 16 is an enlarged, section view showing the pivot mechanism of the adjustable hinge plate assembly of the guide hinge of FIG. 6;

FIG. 17 is a view similar to that of FIG. 5 and with the adjustable hinge plate assembly adjusted to be lowered from the centered position;

FIG. 18 is a view similar to that of FIG. 5 and with the adjustable hinge plate assembly adjusted to be raised from the centered position;

FIGS. 19 and 20 are simplified representations showing how the gap between the housing assembly of the adjustable hinge plate assembly and the frame mounting plate remains substantially constant during horizontal adjustment in the position of the door;

FIG. 21 is an exploded view of a set hinge of an alternative hinge set in accordance with the invention;

FIG. 22 is an exploded view of a set hinge of a non-handed hinge set in accordance with the invention;

FIG. 23 is a view similar to that of FIG. 17 and showing the set hinge of FIG. 22 oriented for mounting a door in a first-handed installation and with the adjustable hinge plate assembly of the set hinge of FIG. 22 adjusted to a position that causes the door to be lowered from a centered position;

FIG. 24 is a view similar to that of FIG. 23 and with the set hinge rotated 180° to be oriented for mounting the door in the opposite-handed installation, and with the adjustable hinge plate assembly of the set hinge adjusted to a position that causes the door to be lowered from a centered position;

FIG. 25 is an enlarged assembled, fragmentary view of a portion of the set hinge of FIG. 21; and

FIG. 26 is an exploded view of a guide hinge of a hinge set in accordance with the invention and which includes a non-headed hinge pin in the manner of the set hinge of FIG. 22.

### DETAILED DESCRIPTION OF THE PREFERRED EMBODIMENT

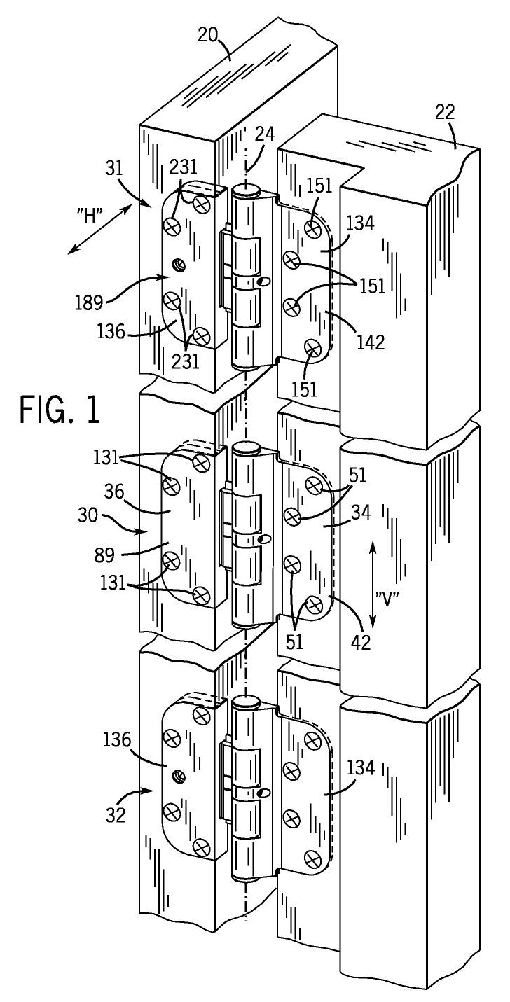

Referring to the drawings, FIG. 1 illustrates a hinge set in accordance with the present invention, shown used to mount a door 20 on a frame 22 for pivoting of the door 20 about an axis 24 relative to the normally stationary frame 22. The hinge set comprises a set hinge 30 and at least one and preferably two guide hinges including an upper guide hinge 31 and a lower guide hinge 32. The set hinge 30 is located near the middle of the door 20. The upper guide hinge 31 and the lower guide hinge 32 are located near the upper and lower edges, respectively, of the door 20. The hinge set enables independent adjustment of the position of the door relative to the frame in both vertical and horizontal directions. The set hinge 30 is adjustable vertically, in a direction “V” that is parallel to the door pivot axis 24, providing vertical adjustment in the position of the door. The guide hinges 31 and 32 are adjustable horizontally in a direction “H” that is transverse to the door pivot axis 24, providing horizontal adjustment in the position of the door. The components of the guide hinges 32 are identical with the components of the set hinge 30, except that the guide hinges and the set hinge differ in that they include different threaded adjustment components. Accordingly, only the set hinge 30 is described in detail. Preferably, the set hinge 30 provides only vertical position adjustment for the door and the guide hinges 31 and 32 provide only horizontal position adjustment for the door. However, since the components of the set and guide hinges are substantially identical, the set and guide hinges can incorporate the necessary adjustment components to permit the set and/or guide hinges to provide both vertical and horizontal position adjustments.

### Set Hinge

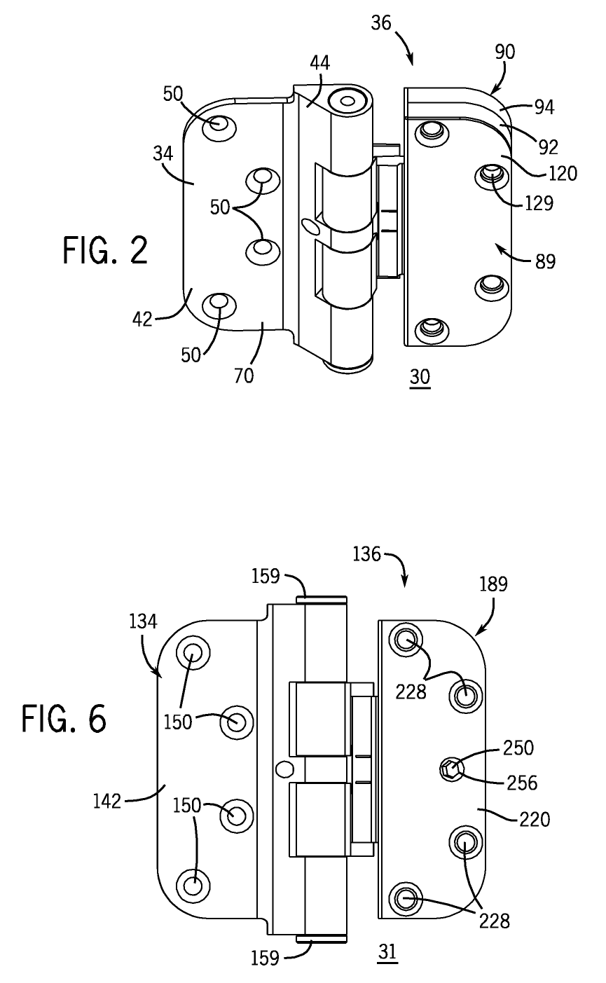

Referring also to FIGS. 2-5, the set hinge 30 includes a mounting plate 34 and an adjustable hinge plate assembly 36 (FIG. 2) which are coupled together by a removable hinge pin 40. The mounting plate 34 includes a mounting portion 42 and a body portion 44 having three curved portions or knuckles 45-47, defining hinge sleeves that have axial openings 48 that provide a cylindrical opening which extends vertically along the extent of one edge of the mounting plate. The axial openings of the knuckles 45 and 47 are countersunk, defining recesses 61 and 63 as shown in FIG. 5, for example. Recess 63 receives the head portion 65 of the hinge pin 40. The axial opening 48 in the knuckle 47 is adapted to receive a vertical height adjustment screw 52 which, together with the axial opening 48, form a vertical height adjustment mechanism. The vertical height adjustment screw 52 extends coaxially with the hinge pin 40. The mounting portion 42 includes apertures 50 for receiving mounting fasteners 51, such as screws (FIG. 1) or any other suitable fastener, that attach the mounting plate 34 to the door frame 22. The hinge pin 40 is removable to facilitate removing the door from the door frame whenever necessary.

The vertical height adjustment screw 52 is received in the lowermost knuckle 47 of the mounting plate, hereinafter, frame mounting plate 34. The vertical height adjustment screw 52 has a threaded outer surface 55 that engages a mating threaded inner surface of the knuckle 47. The upper end of the vertical height adjustment screw 52 includes a cylindrical aperture 53 which receives the bottom end of the hinge pin 40. The lower end of the vertical height adjustment screw 52 has a recess 57 (FIG. 5), which can be hexagonal in shape or some other shape suitable for receiving a tool, such as a hex wrench, screw driver, torque-drive, etc., for turning the vertical height adjustment screw 52 to raise and lower the adjustable hinge plate assembly 36 relative to the frame mounting plate 34, providing vertical height adjustment for the door 20.

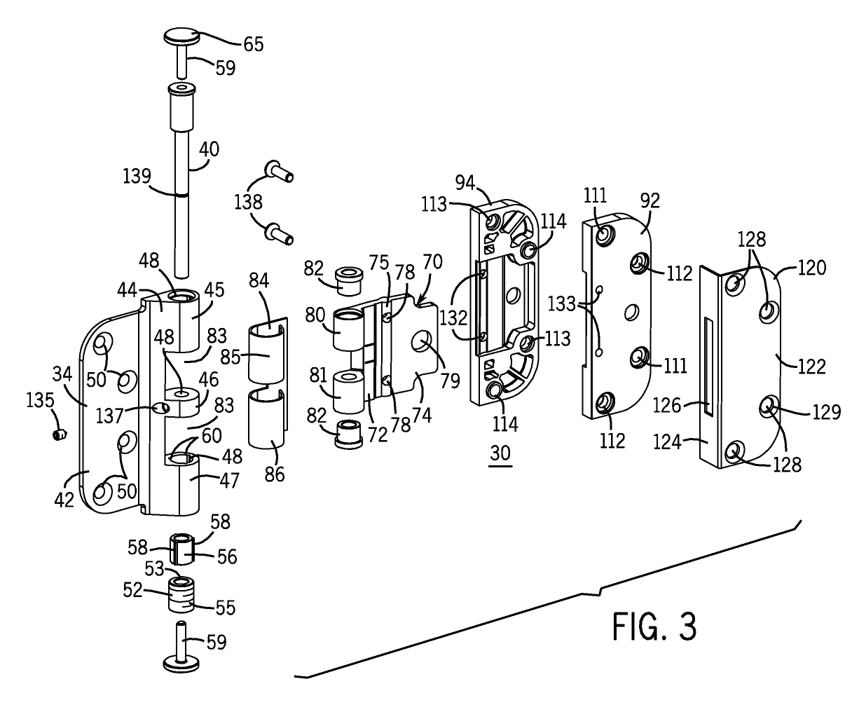

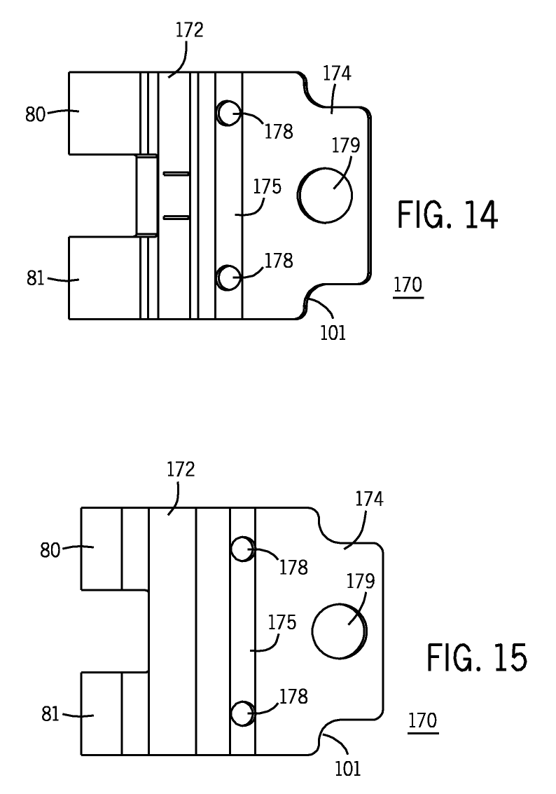

Referring to FIGS. 3-5, the adjustable hinge plate assembly 36 includes an adjustment member which can be in the form of a plate 70 having a base portion 72 and a tongue 74 extending from the base portion 72 at one edge. The tongue 74 defines a pivot 75 that extends from the top edge to the bottom edge of the tongue and includes a tapped aperture 79. Referring to FIGS. 14-16, the pivot 75 and the tapped aperture 79, which are part of the horizontal adjustment mechanism, correspond to a pivot 175 and aperture 179 of the adjustment plate 170 of the guide hinges 31 and 32, as is described below. As has been stated above, the components of the guide hinges 32 are identical with the components of the set hinge 30, except that the guide hinges and the set hinge differ in that they include different threaded adjustment components. The tongue 74 further includes mounting apertures 78 that extend through the pivot 75. The apertures 78 facilitate securing the adjustment plate 70 to a housing assembly 89 (FIG. 5) of the adjustable hinge plate assembly 36, with the pivot 75 fixed against axial movement relative to the housing assembly 89. The housing assembly 89 is adapted to mount the adjustable hinge plate assembly 36 of the set hinge to the door 20 being hung. The adjustable hinge plate assembly 36 is adapted to be mounted recessed into the edge of the door 20. Alternatively, the mounting plate 34 of the set hinge 30 can be mounted recessed on the door in which case the adjustable hinge plate assembly 36 would be mounted recessed on the door frame.

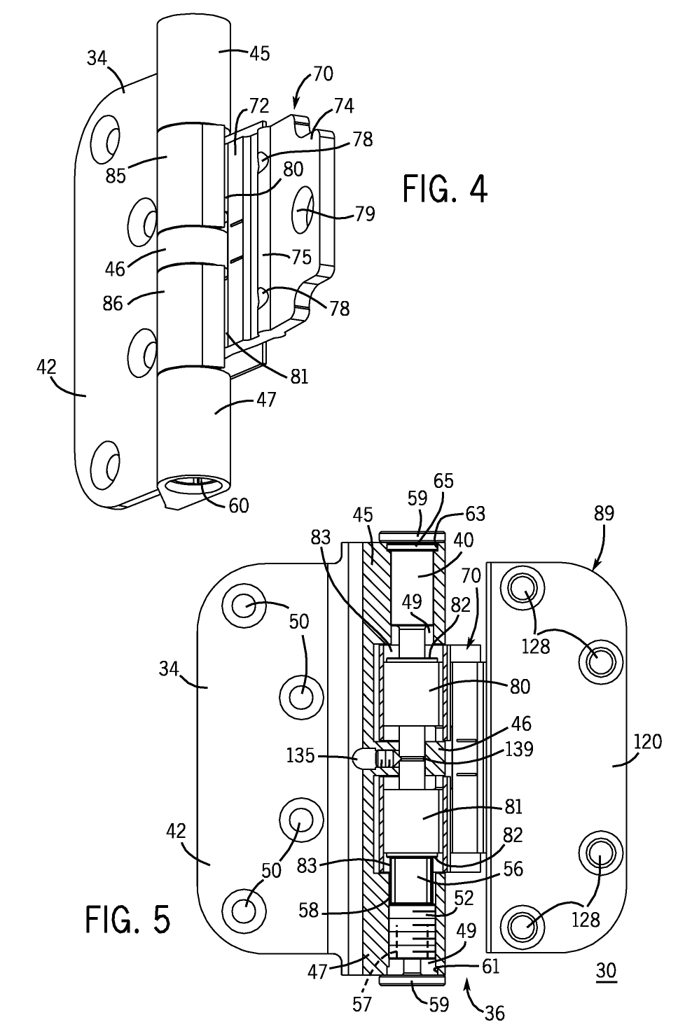

The adjustment plate 70 includes two cylindrical projections or knuckles 80 and 81, forming an intermediate hinge sleeve at one end. The knuckles 80 and 81 are configured and dimensioned to be aligned with and to mesh with the knuckles 45, 46 and 47 on the frame mounting plate 34 as shown in FIG. 4, for example, with the knuckles 80 and 81 located in the spaces 83 (FIG. 3) between adjacent knuckle pairs 45,46 and 46,47 on the frame mounting plate 34. As shown in FIG. 5, the vertical length of each of the knuckles 80 and 81 on the adjustment plate 70 is less than the vertical length of the spaces 83 between the adjacent knuckle pairs 45,46 and 46,47 on the frame mounting plate 34. This allows the adjustment plate 70 to be moved freely up and down in a vertical direction relative to the frame mounting plate 34. Press-fit inserts 82 are inserted into the ends of the knuckles 80,81.

An adjustment plate cover 84 is mounted on the adjustment plate 70 in overlying relationship with the knuckles 80 and 81. The adjustment plate cover 84 includes a pair of generally cylindrical projections 85,86 that overlie the two knuckles 80 and 81 of the adjustment plate 70. The knuckles 80 and 81 are dimensioned to allow the knuckles 80 and 81 to move, relative to the adjustment plate cover, and vertically up and down within the spaces 83. The lengths of the projections 85 and 86 of the adjustment plate cover 84 are approximately the same as the lengths of the spaces between the adjacent knuckle pairs 45,46 and 46,47 on the frame mounting plate 34, allowing knuckles 80 and 81 to be received between respective knuckle pairs 45,46 and 46,47. The frame mounting plate 34 and the adjustable hinge plate assembly 36 are connected together by positioning the knuckles 80 and 81 into the gaps between the knuckle pairs 45,46 and 46,47 and inserting the hinge pin 40 into the cylindrical opening defined by the mating knuckles of the frame mounting plate 34 and the adjustment plate 70.

Referring to FIGS. 3 and 5, the hinge pin 40 includes a groove 139 at a central location thereon. The groove 139 can be an annular V-shaped groove that is formed in the shank of the hinge pin 40 in any suitable way, such as by machining. A set screw 135, which is threadingly received in a tapped aperture 137 in the frame mounting plate 34, adjacent to the knuckle 44, can be tightened to engage the hinge pin 40 to fix the hinge pin 40 to the frame mounting plate 34. Pins or finials 59 can be inserted into the opposite ends of the hinge pin 40. The shanks of the finials 59 can be threaded, allowing the finials to be threadingly received in tapped recesses in opposite ends of the hinge pin 40. Alternatively, the finials can be held in place in the ends of the hinge pin 40 by friction fit.

Reference is now made to FIG. 4 along with FIGS. 3 and 5. FIG. 4 is an isometric view of an assembly of a frame mounting plate and an adjustment plate of the set hinge 30, shown with the vertical height adjustment screw 52 removed. As shown in FIG. 5, an anti-rotation collar 56 is mounted in a portion of the axial opening 48 formed by the lowermost knuckle 47 of the frame mounting plate 34, coupling the vertical height adjustment screw 52 to the lower surface of the adjustment plate 70. The anti-rotation collar 56 includes one or more wings or projections 58 that are received in grooves or slots 60 formed on the interior wall of the knuckle 47 as shown in FIGS. 3 and 4, indexing the anti-rotation collar to the mounting plate 34. The anti-rotation collar 56 prevents the vertical height adjustment screw 52 from turning as the door 20 is opened and closed.

As shown in FIG. 5, the anti-rotation collar 56 is interposed between the upper end of the vertical height adjustment screw 52 and the lower end of the knuckle 81 of the adjustment plate 70. Accordingly, as the vertical height adjustment screw 52 is turned in one direction, the anti-rotation collar 56 is moved vertically upward, moving the adjustment plate 70 upwardly, thereby adjusting the vertical position of the door 20 relative to the door frame 22. Turning the vertical height adjustment screw 52 in the opposite direction allows the anti-rotation collar 56 and the adjustment plate 70 to be moved vertically downwardly aided by the weight of the door.

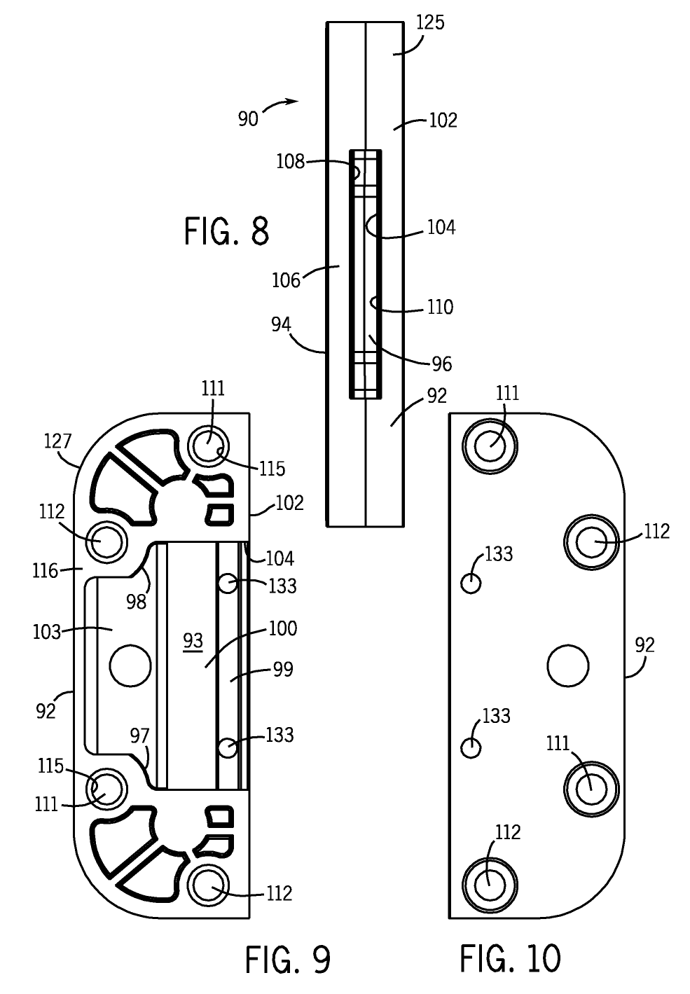

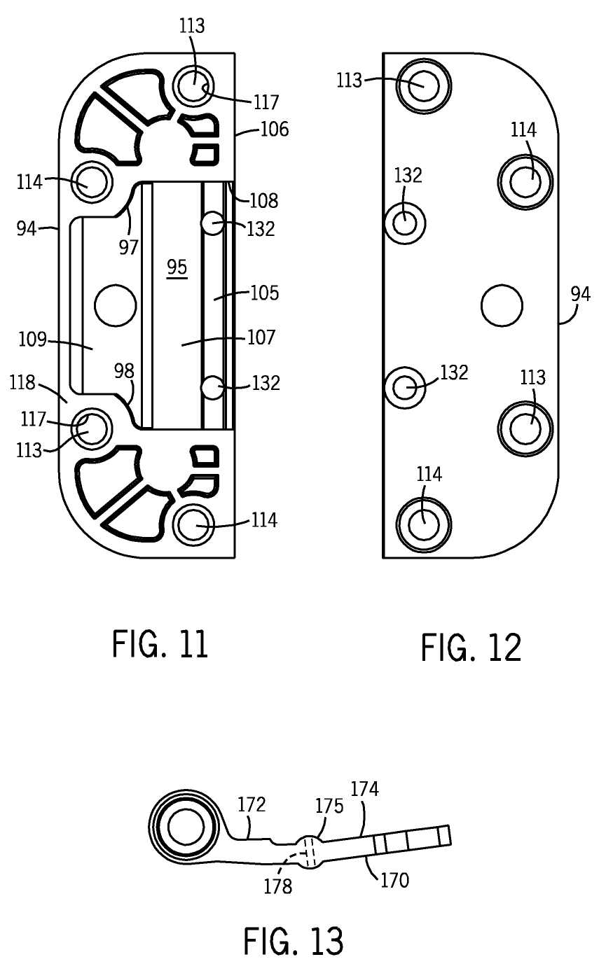

Referring also to FIGS. 9-12, the housing assembly 89 (FIG. 5) includes a two-part housing 90 (FIG. 8) having a housing front 92 (FIGS. 9-10) and a housing back 94 (FIGS. 11-12). The housing front 92 and the housing back 94 are adapted to be assembled together, forming a closed housing. The housing front 92 and the housing back 94 have recessed inner surfaces 93 and 95, respectively, shown in FIGS. 9 and 11. When the housing front 92 and the housing back 94 are assembled together, the inner surfaces 93 and 95 define a housing central cavity 96 (FIG. 8) which receives the tongue 74 of the adjustment plate 70. As is described below with reference to the guide hinges 31 and 32, the housing 90 has curved interior side walls 97 and 98, shown in FIGS. 9 and 11, that are complementary in shape to the shape of the periphery 101 of the tongue 74 (FIG. 14) of the adjustment plate 70. The housing front 92 includes a side wall 102 and the housing back 94 includes a side wall 106. The side wall 102 includes a notch 104 which mates with a corresponding notch 108 in side wall 106, defining a slot 110 (FIG. 8) when the housing front 92 and the housing back 94 are assembled together. The notches 104 and 108, which are generally rectangular in shape, define a generally rectangular slot 110 (FIG. 8) that extends along the forward end 125 of the housing 90, providing an entryway into the central cavity 96 of the housing 90.

From the notch 104 at the forward end 125 of the housing front 92 towards the opposite or rearward end 127, the inner surface 93 of the housing front 92 includes an arcuate trough portion 99, which is connected by an inwardly slanting surface portion 100 with a generally flat portion 103 near the rearward end 127 of the housing front 92. Similarly, from the notch 108 at the forward end of the housing back 94 towards the opposite or rearward end, the inner surface 95 of the housing front 92 includes an arcuate trough portion 105, an inwardly slanting surface portion 107 and a generally flat portion 109.

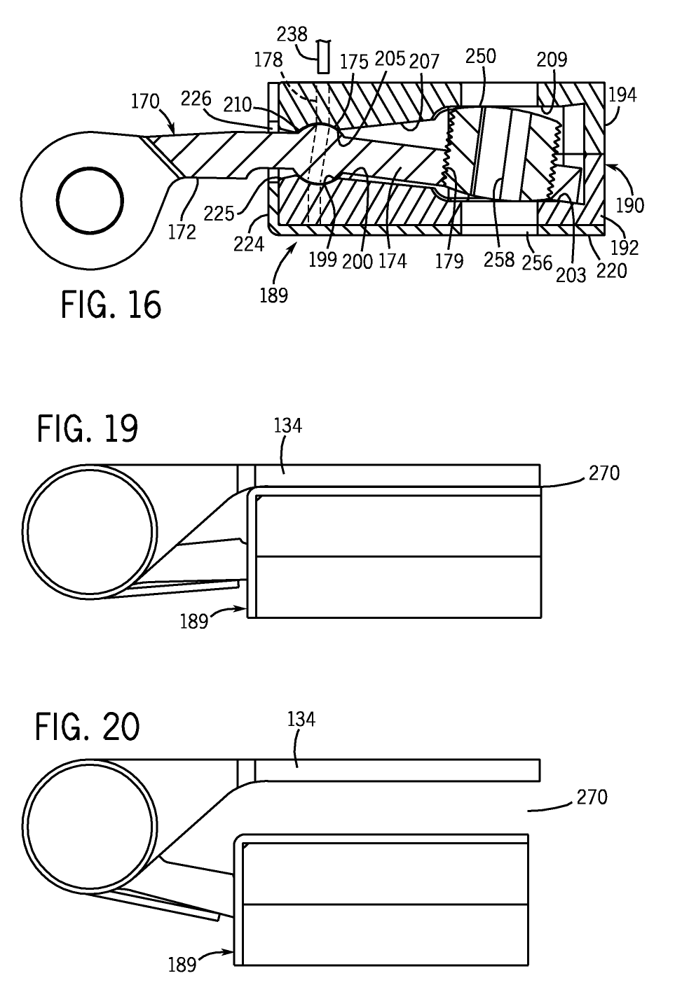

The cross-sections of the housing front 92 and housing back 94 are the same as those for the housing front 192 and housing back 194 of the guide hinge, a sectional view of which is shown in FIG. 16, which includes an arcuate trough 199, which is connected by an inwardly slanting surface portion 200 with a generally flat portion 203. The configuration of the inner surface 93 of the housing front 92 conforms generally to the configuration of the tongue 74 and the pivot 75 of the adjustment plate 70.

Referring to FIGS. 3 and 9-12, the housing front 92 and the housing back 94 include a locking mechanism, formed by mating mounting portions of the housing front 92 and housing back 94, that secures the housing front 92 to the housing back 94. To this end, the housing front 92 includes a first pair of mounting apertures 111 and a second pair of mounting apertures 112 therethrough. Similarly, the housing back 94 includes a first pair of mounting apertures 113 and a second pair of mounting apertures 114 therethrough. The mounting apertures 111 each terminate in a cylindrical skirt 115 that projects inwardly from the inner surface 116 (FIG. 9) of the housing front 92. The mounting apertures 112 are countersunk on the inner surface 116 of the housing front. Similarly, the mounting apertures 113 each terminate in a cylindrical skirt 117 that projects inwardly from the inner surface 118 of the housing back 94 and the mounting apertures 114 are countersunk. The housing back 94 includes apertures 132 that extend through the housing back near opposite ends of the trough 105. The housing front 92 includes apertures 133 that extend through the housing front near opposite ends of the trough 99.

The housing front 92 and the housing back 94 are identical except that the apertures 132 in the housing back 94 are countersunk for a reason to be described. In assembling together the housing front 92 and the housing back 94, one of the housing members, such as the housing back 94, is rotated end-over-end so that the projecting skirts 115 of the mounting apertures 111 of the housing front 92 are received in an interference fit in the countersunk mounting apertures 114 of the housing back 94. Likewise, the projecting skirts 117 of the mounting apertures 113 of the housing back 94 are received in an interference fit in the countersunk mounting apertures 112 of the housing front 92. Making the housing front 92 and the housing back 94 substantially identical both simplifies the manufacture of these components and reduces manufacturing costs for the hinge set.

Referring to FIGS. 2, 3 and 5, the housing assembly 89 further includes a housing cover 120, which is adapted to be mounted over the two-part housing 90. The housing cover 120 includes a generally flat mounting portion 122 and an outwardly extending flange 124 that overlies the forward end 125 of the housing 90, partially covering the slot 110 in the edge of the housing 90. The flange 124 includes a slot 126 (FIG. 3), generally rectangular in shape, that is smaller in size than the slot 110. The mounting portion 122 of the housing cover 120 includes a plurality of mounting apertures 128. The housing cover 120 is mounted onto the housing 90 with the flange 124 overlying the forward end 125 of the housing 90, exposing a portion of the slot 110 through the slot 126, with the mounting apertures 128 of the housing cover 120 aligned with the mounting apertures 111-114 in the housing front 92 and the housing back 94. Each of the mounting apertures 128 terminates in a cylindrical skirt 129 that projects inwardly from the inner surface of the housing cover 120 and each being received in an interference fit in one of countersunk portions of the mounting apertures 111-112 of the housing cover 92, for securing the housing cover 120 to the housing 90. The aligned mounting apertures 111-114 and 128 allow mounting fasteners 131, such as screws (FIG. 1) or any other suitable fasteners, to pass through the aligned mounting apertures for securing the housing assembly 89 to the door 20.

The adjustment plate 70 is attached to the housing assembly 89 by inserting the tongue 74 of the adjustment plate 70 through the slot 126 in the housing cover 120 and the slot 110 defined by the housing front 92 and the housing back 94. When inserted into the housing, the adjustment plate tongue 74 is located centrally of the housing 90 between the housing front 92 and the housing back 94. The adjustment plate tongue 74 is coupled to the housing 90 by coupling members 138, which can be screws or any other suitable fasteners, which extend through the apertures 132 through the housing back 94, the apertures 78 through the pivot 75, and the apertures 133 through the housing front 92. The screws 138 can be screwed into the housing 90 to retain the adjustment plate tongue 74 in the housing 90. The apertures 132 can be countersunk at the outer surface of the housing back 94, as shown in FIG. 12, to accommodate the heads of the screws 138.

### Guide Hinges

Referring to FIGS. 1, 6, 7 and 13-16, as is stated above, both of the guide hinges 31 and 32 are identical to the set hinge 30 shown in FIGS. 2-5 and except for the threaded adjustment components used to provide horizontal or vertical adjustment in the position of the door 20. Accordingly, components of the guide hinge 31, as well as guide hinge 32, have been given the same reference numbers as corresponding components of the set hinge 30 but incremented by 100. Moreover, because the guide hinges 31 and 32 are identical, only guide hinge 31 is described.

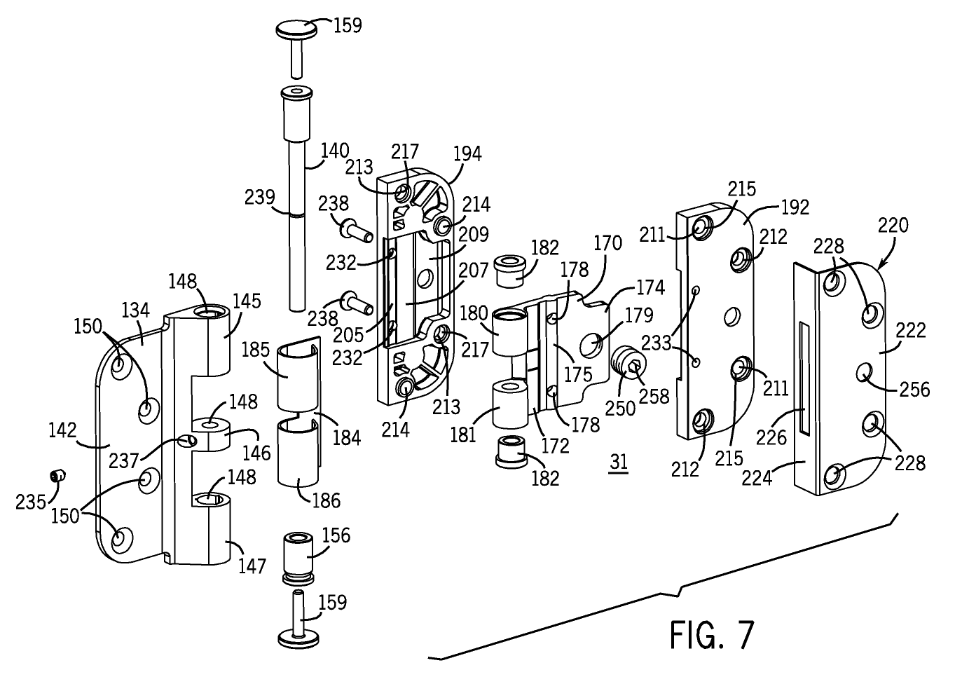

More specifically, the guide hinges 31 and 32 are identical to the set hinge 30 except for the following differences. Each of the guide hinges 31 and 32 includes a horizontal position adjustment screw 250. Also, the housing cover 220 includes an access hole 256 to provide access to the horizontal position adjustment screw 250 for making horizontal adjustments in the position of the door. In addition, the guide hinges 31 and 32 do not include the threaded vertical height adjustment screw 52 (FIG. 5) of the set hinge 30 and the guide hinges 31 and 32 include a modified anti-rotation collar 156 shown in FIG. 7. The function of the horizontal position adjustment screw 250 of the guide hinge 31 is described in detail below. The structure and function of the other components of the guide hinge 31 are evident from the description of the set hinge 30 above, and accordingly, will not be described in detail.

Briefly, the guide hinge 31 includes a frame mounting plate 134 and an adjustable hinge plate assembly 136 which are coupled together by a removable hinge pin 140 (FIG. 7). In the case of the guide hinge 31 (as well as guide hinge 32), which does not include a vertical height adjustment screw, the adjustable hinge plate assembly 136 is free to move vertically up and down with respect to the frame mounting plate 134 and the frame, allowing the door 20 to which the adjustable hinge plate assembly 136 is mounted to be moved up and down when the set hinge is being adjusted. The mounting portion 142 of the frame mounting plate 134 includes apertures 150 for receiving mounting fasteners 151, such as screws, shown in FIG. 1, or any other suitable mounting fasteners, that attach the frame mounting plate 134 to the door frame 22. The adjustable hinge plate assembly 136 includes an adjustment member, such as a plate 170, and a housing assembly 189 (FIG. 6). The adjustment plate 170 includes knuckles 180 and 181, forming hinge sleeves which mesh with knuckle pairs 145,146 and 146,147, or hinge sleeves, of the frame mounting plate 134 and are coupled together by the hinge pin 140, forming a pivot hinge for the door 20 being hung. The anti-rotation collar 156 is located within the knuckle 147. The length of the anti-rotation collar 156 is greater than that of the anti-rotation collar 56 to compensate for the space in the portion of the cylindrical opening 148 of knuckle 47 vacated due to the omission of the vertical height adjustment screw. Optionally, a cylindrical screw can be screwed into the bottom cylindrical projection of the frame mounting plate 134 to retain the anti-rotation collar 156 therein. The adjustable hinge plate assemblies 136 of the guide hinges 31 and 32 are adapted to be mounted recessed into the edge of the door 20. As indicated above for the set hinge, alternatively, the mounting plates 134 of the guide hinges 31,32 can be mounted recessed on the door in which case the adjustable hinge plate assemblies 136 would be mounted recessed on the door frame. The hinge pin 140 is removable to facilitate removing the door from the door frame whenever necessary.

The hinge pin 140 includes a groove 239 formed thereon. The groove 239 can be an annular V-shaped groove formed in the shank of the hinge pin 140 at a central location. A set screw 235, threadingly received in a threaded aperture 237 in the frame mounting plate 134 adjacent to the knuckle 146, is tightened to engage the hinge pin 140 to fix the hinge pin 140 to the frame mounting plate 134. Pins 159 can be inserted into the opposite ends of the hinge pin 140.

Referring to FIGS. 7 and 13, the adjustment plate 170 includes a base portion 172 and a tongue 174. The tongue 174 has apertures 178 for securing the adjustment plate 170 to the housing assembly 189. The adjustment plate 170 defines a pivot 175 which is formed on one end of the adjustment plate 170 and which extends from the upper to the lower vertical edges of the adjustment.

Referring to FIGS. 7 and 16, the housing assembly 189 includes a housing 190 formed by a housing front 192 and a housing back 194, and a housing cover 220. The housing front 192 and the housing back 194 are identical to one another (and to the housing front 92 and the housing back 94) except that apertures 232 in the housing back 194 are countersunk. The housing front 192 and the housing back 194 are secured together by mating parts, including mounting apertures 211-214 having skirts 215,217 that are received in interference fit in the manner described above for the housing front 92 and housing back 94. The housing front 192 and the housing back 194 define a slot 210 (FIG. 16) on the forward end 225 of the housing 190 that corresponds to the slot 110 of the housing 90 of the set hinge 30. The adjustment plate 170 extends through the slot 210.

The housing cover 220 includes a mounting portion 222 and a flange 224 having a slot 226 shown in FIG. 16, for example. The housing cover 220 is mounted onto the housing 190 with the flange 224 overlying the forward end 225 of the housing 190 (FIG. 16), exposing only a portion of the slot 210 in the housing 190 through the slot 226 in the housing cover 220. In addition, mounting apertures 228 of the housing cover 220 are aligned with the mounting apertures 211-214 in the housing front 192 and the housing back 194, allowing mounting screws 231 (FIG. 1) to pass through the aligned mounting apertures for securing the housing assembly 189 to the door 20. The housing cover 220 is secured to the housing 190 in the manner described above for housing cover 120 and the housing 90 of the set hinge.

Referring to FIG. 16, the housing front 192 and the housing back 194 define a cavity that receives the adjustment plate tongue 174. The adjustment plate tongue 174 is inserted into the housing 190 through the aligned slots 226 and 210 in the housing cover 220 and the housing 190. The pivot 175 is received in a cylindrical cavity defined by the arcuate trough 199 of the housing front 192 which mates with the arcuate trough 205 of the housing back 194 as shown in FIG. 16. The trough 205 for the housing back 194 is shown in FIG. 7 which also shows the inwardly slanting surface portion 207 and the recessed, generally flat portion 209 of the housing back 194. The trough 199, inwardly slanting surface portion 200, and the recessed, generally flat portion 203 of the housing front 192 correspond to the trough 99 and surface portions 100 and 103 of the set hinge housing front 92 shown in FIG. 11, for example. The configuration of the inner surface 193 of the housing front 192 (and of the housing back) conforms generally to the configuration of the adjustment plate tongue 174 and the pivot 175 of the adjustment plate 170.

The adjustment plate tongue 174 is secured to the housing 190 by screws 238 which extend through the apertures 232 through the housing back 194, the apertures 178 through the pivot 175, and mating apertures 233 (FIG. 7) through the housing front 192. The screws 238 can be screwed into the housing 190 to retain the adjustment plate tongue 174 in the housing 190. The pivot 175 is fixed against axial movement by the two screws 238 which secure the tongue 174 within the housing 190. The apertures 232 can be countersunk at the outer surface of the housing back 194 to accommodate the heads of the screws 238. The vertical length of the adjustment plate tongue 174 is less than the vertical length of the slot 226 to allow the adjustment plate tongue to be moved up and down within the housing 190. This allows vertical adjustments in the position of the door to be made using the set hinge 30 without affecting horizontal position settings made using either or both of the guide hinge sets 31 and 32.

Referring to FIGS. 7, 14 and 16, the horizontal position adjustment screw 250 is generally cylindrical in shape and has its peripheral edge threaded. The horizontal position adjustment screw 250 is mounted on the tongue 174, which is located within the cavity 196 of the two-part housing 190 when assembled. The horizontal position adjustment screw 250 is screwed into a tapped aperture 179 in the tongue 174 of the adjustment plate 170 located near the end of the adjustment plate 170 opposite to the location of the pivot. The horizontal position adjustment screw 250 has a recess 258 located on the bottom thereof for receiving a tool for turning the horizontal position adjustment screw 250. By way of example, the side wall of the recess 258 can be hex-shaped. The horizontal position adjustment screw 250 is used to adjust the angle by which the adjustment plate 170 extends from the housing 190. This adjustment effectively adjusts the horizontal position of the door 20 relative to the door frame 22.

Because the pivot 175 is located between the location of the hinge pin 140 and the location of the horizontal position adjustment screw 250, and is fixed, such as by the screws 238, against axial movement with respect to the housing 190, adjusting the horizontal position adjustment screw 250 causes the adjustment plate 170 to be moved substantially in a horizontal direction when the horizontal position adjustment screw is turned clockwise or counterclockwise. Thus, the door 20 is moved substantially horizontally when either one of the guide hinges 31 or 32 is being adjusted.

The housing cover 220 includes an aperture 256 providing access to the access opening in the housing front 192. As shown in FIG. 6, the head of the horizontal position adjustment screw 250 is visible through the opening 256. Digressing, with reference to FIGS. 2 and 3, it is pointed out that the housing cover 122 of the set hinge 30 does not include an opening corresponding to the aperture 256 and so the access opening in the housing 90 is covered by the housing cover 120. This is a further difference between the guide hinges 31 and 32 and the set hinge 30. When the set hinge 30 is mounted on a door, the housing back 94 lies flush against the surface of the door 20 so that the opening in the housing back 94 is covered by the door. The housing covers 220 for the guide hinges 31 and 32 are identical to the housing cover 120 for the set hinge 30 except for the additional opening 256.

While the horizontal position adjustment screw 250 moves with the tongue 174 when a vertical position adjustment is being made, the horizontal position adjustment screw 250 remains visible through the access opening 256, to be accessible through the access opening 256 to permit adjustment in the horizontal position of the door 20 following the vertical adjustment.

The following is a summary of the differences between the set hinge 30 and the guide hinges 31 and 32. Except for the presence of the vertical height adjustment screw 52 and the use of a different anti-rotation collar 56, the components of the frame mounting plate 34 of the set hinge 30 are the same as the components of the frame mounting plate 134 of the guide hinges 31 and 32. Also, except for the addition of the horizontal position screw 250 and the provision of the access opening 256 in the housing cover 220, the components of the adjustable hinge plate assembly 136 of the guide hinges 31 and 32 are the same as the components for the adjustable hinge plate assembly 36 of the set hinge 30. The use of common parts in both the set hinge and the guide hinges results in a significant reduction in manufacturing and assembly costs for the hinge set as well as in the cost for parts inventory.

### Vertical Adjustment of the Door Position

The position of the vertical height adjustment screw 52 is adjustable vertically along a vertical axis to reposition the adjustment member 70 vertically relative to the frame mounting plate 34, thereby repositioning the door vertically. Referring to FIGS. 1 and 5, to adjust the vertical position of the door 20, the installer rotates the vertical height adjustment screw 52 of the set hinge 30. The installer inserts a tool, such as a screw driver or torque-drive, into the recess at the lower end of the frame mounting plate 34, and turns the vertical height adjustment screw 52 to obtain the vertical position desired for the door. Turning the vertical height adjustment screw 52 moves the adjustment plate 70 up and down to adjust the height of the door 20 in the door frame 22. The clearance between the adjustment plate 70 and the knuckles on the frame mounting plate 34 allows for vertical adjustment in the position of the door. The adjustment plate 70 can be moved up or down with respect to the frame mounting plate 34, thereby moving the door vertically up or down. In addition, because the guide hinges 31 and 32 do not include vertical adjustment screws, the adjustment plates 170 of the guide hinges 31 and 32 can move freely up or down relative to the frame mounting plates 134 as the adjustment plate 70 is moved up or down. In accordance with the present invention, the guide hinges 31 and 32 and the set hinge 30 allow vertical adjustment in the position of the door using to be made without affecting the horizontal position to which the door has been previously set.

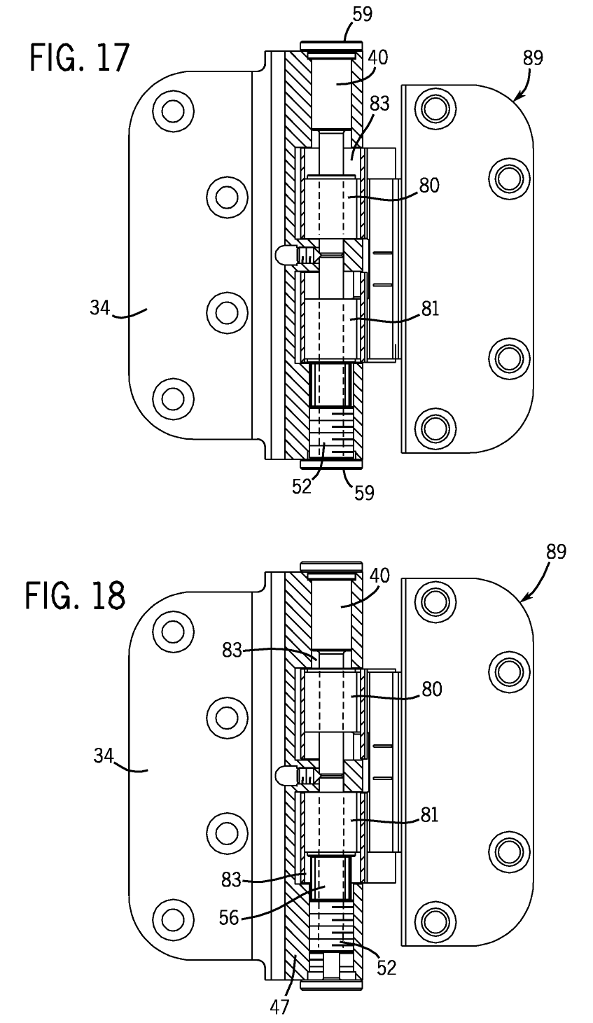

FIG. 5 is a view of the set hinge with the adjustable hinge plate assembly 36 located in a centered position. By adjusting the threaded vertical height adjustment screw 52, the adjustment plate 70 may be moved up and down to adjust the height of the door in the door frame. FIG. 17 is a view similar to that of FIG. 5 and with the adjustable hinge plate assembly 36 adjusted to a position that results in the door 20 being lowered in the door frame 22. FIG. 18 is a view similar to that of FIG. 5 and with the adjustable hinge plate assembly 36 adjusted to a position that results in the door 20 being raised in the door frame 22.

### Horizontal Adjustment of the Door Position

Referring to FIG. 16, horizontal adjustment in the position of the door is made by adjusting the horizontal position adjustment screw 250 of one or both of the guide hinges 31 and 32. In accordance with the present invention, the set hinge 30 and the guide hinges 31 and 32 allow horizontal adjustment in the position of the door using to be made without affecting the vertical position to which the door has been previously set. The horizontal position adjustment screw is adjustable to pivot the adjustment plate 170 relative to the housing 190 about a pivot axis defined by the fixed pivot 175, changing the angular position of the adjustment plate relative to the housing 190, thereby moving the adjustable hinge plate assembly 136 relative to the mounting plate 134 in a substantially horizontal direction.

More specifically, the horizontal position of the door can be adjusted by inserting a tool into the recess 258 in the head of the horizontal position adjustment screw 250 and turning the horizontal position adjustment screw 250 clockwise or counterclockwise. Turning the horizontal position adjustment screw 250 pivots the adjustment plate 170 on the pivot 175, moving the end of the adjustment plate 170 in or out to adjust the horizontal position of the door in the door frame, depending upon the direction in which the horizontal adjustment screw is being turned. Turning the horizontal position adjustment screw 250 causes the tongue 174 to pivot, in cantilever fashion, about the pivot axis defined by the pivot 75, moving the door outwardly or inwardly in a horizontal direction. However, because the pivot 175 is fixed, the base 172 of the adjustment plate 170 does not pivot. Because of this, and because the pivot point is spaced apart from the location of the horizontal adjustment screw 250, the frame mounting plate 134 remains substantially parallel to the surface of the housing 190 as a horizontal adjustment is being made. Thus, as the door is moved outwardly horizontally from an initial position, represented by the position of the housing assembly 189 of the adjustable plate assembly 136 relative to the frame mounting plate 134 as illustrated in FIG. 19, to an adjusted position, represented by the position of the housing 189 relative to the frame mounting plate 134 as illustrated in FIG. 20, the gap 270 between the housing assembly 189 and the frame mounting plate 134 remains substantially constant.

The slot 126 in the housing 90 of the set hinge and the slots 226 in the housings 190 of the guide hinges 31 and 32, and the pins and the apertures in the adjustment plate tongues 74 and 174 are dimensioned to allow the knuckle bearing ends of the adjustment plates 70 and 170 to be moved forwardly and rearwardly in a direction transverse to the pivot axis 24 of the door. The adjustable hinge plate assembly 36 also allows vertical adjustment, allowing relative movement between the adjustment plate 70 which is secured to the door frame 22 and the housing 90 which is secured to the door 20.

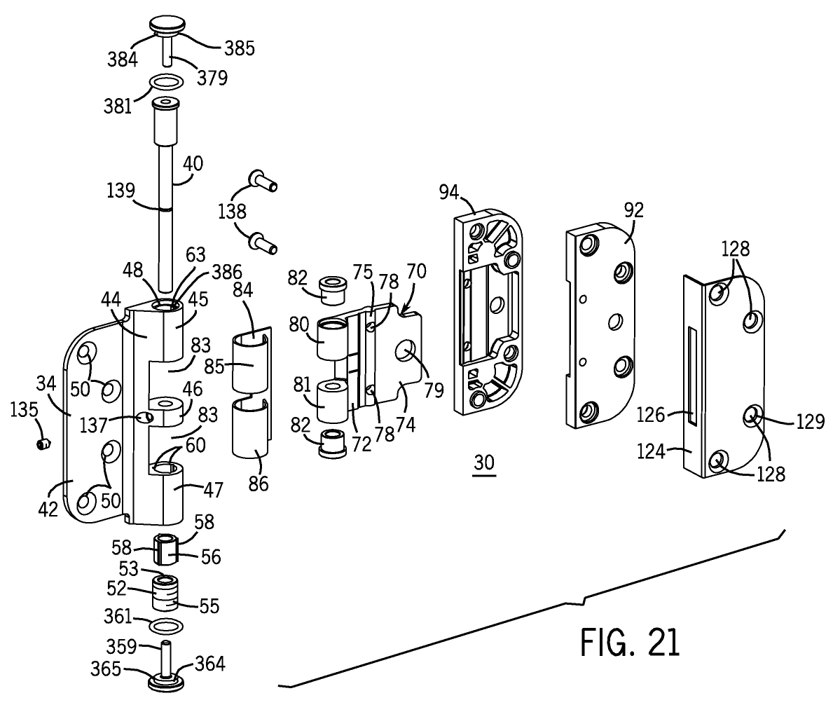

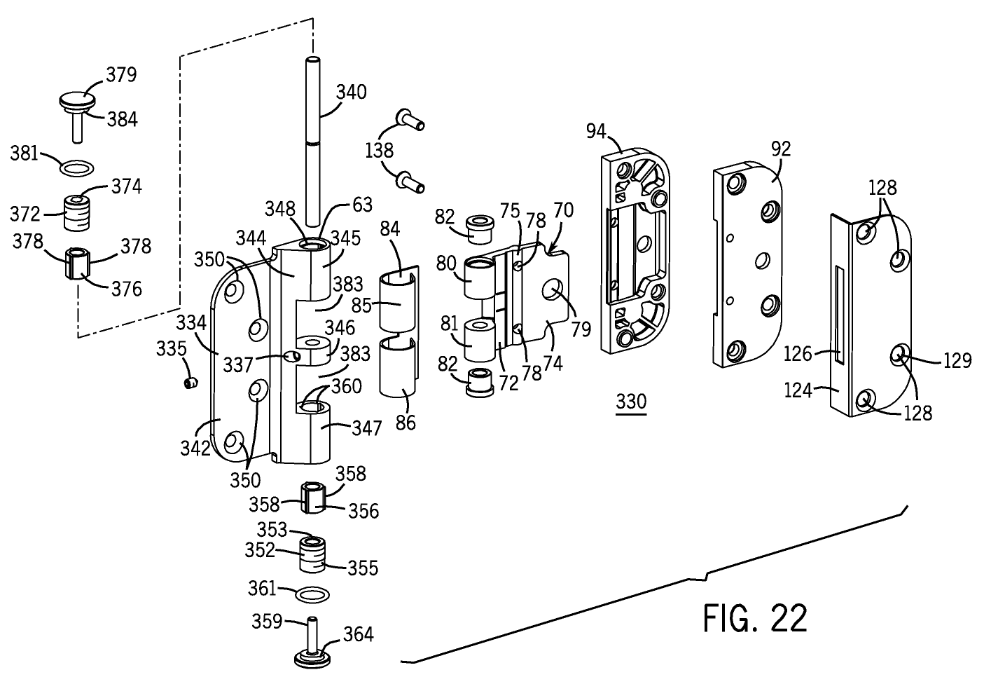

Referring to FIG. 21 and to FIG. 25, which is an enlarged fragmentary view of the lower portion of a set hinge of FIG. 21, in an embellishment, the pins 59 and 79 are replaced by finials 359 and 379 which are adapted to be inserted into the recesses 61 and 63, respectively, in knuckles 45 and 47 at the opposite ends of the mounting plate 34 of the set hinge 30 and held in place by friction fit. The mounting of the finial 379 at the upper portion of the set hinge shown in FIG. 21 is similar to that shown in FIG. 23 for an embodiment illustrated in FIGS. 22-24 including a non-handed hinge. The finials 359 and 379 have annular grooves 364 and 384, respectively, which receive O-rings 361 and 381, respectively. The O-rings 361 and 381 are trapped between the inner surfaces 365 and 385, respectively, of the grooves 364 and 384 and inner surfaces 366 and 386, respectively, of the recesses 61 and 63 in the ends of the knuckles 40, enhancing the friction fit for the finials, while facilitating removal of the finials, for example, by prying the finials out with a suitable tool.

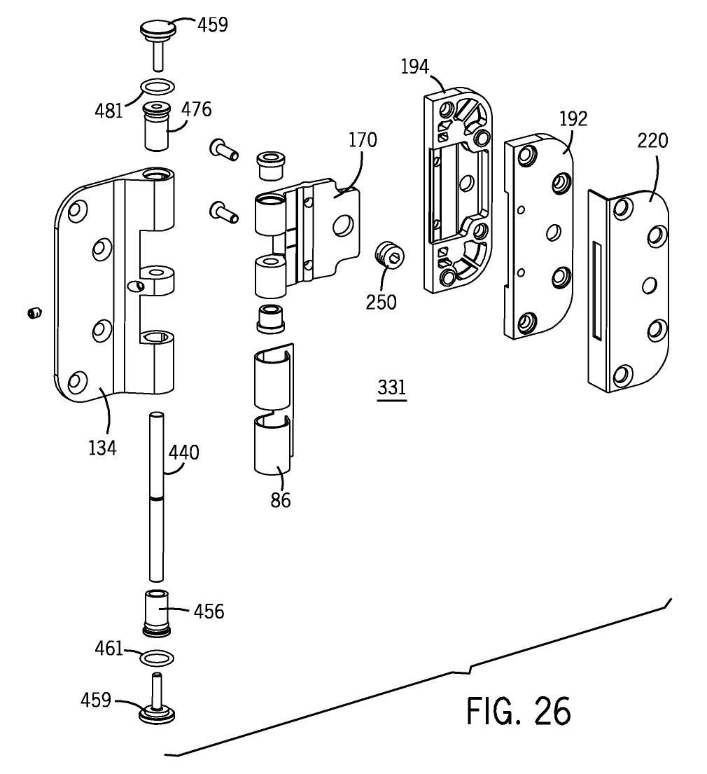

Referring to FIG. 26, in accordance with an embellishment, a guide hinge 331, which is similar to the guide hinge 31 shown in FIG. 7, for example, also can be modified to include a non-headed hinge pin 440 and finials 459, such as the finials 359 and 379 of the set hinges shown in FIGS. 21-25, in place of the pins 159 at opposite ends of the hinge pin 140. The guide hinge 331 is generally similar to the guide hinge 31 shown in FIG. 7, and accordingly, components of the guide hinge 331 have been given the same reference numbers as like components of the guide hinge 31. In guide hinge 331, the pins 159 and 179 of the guide hinge 31 are replaced by finials 459 which are adapted to be inserted into the recesses (corresponding to recesses 61 and 63 of set hinge 330, FIGS. 22 and 25) in knuckles 145 and 147 at the opposite ends of the mounting plate 134 of the guide hinge 31 and held in place by friction fit. The mounting of the finials 459 at opposite ends of the guide hinge is similar to that shown in and described with reference to FIGS. 21-25 for embodiments of set hinges. The finials 459 have annular grooves (corresponding to annular grooves 364 and 384 of set hinge 330) which receive O-rings 461 and 481, respectively, which enhance the friction fit for the finials, while facilitating removal of the finials, for example, by prying the finials out with a suitable tool. The O-rings 461 and 481 are trapped between the inner surfaces of the grooves and inner surfaces of the recesses in the ends of the hinge pin 440, in the manner of O-rings 361 and 381 of set hinge 330 (FIGS. 22-25), which are trapped between inner surfaces 365 and 385, respectively, of the grooves 364 and 384 and inner surfaces 366 and 386, respectively, of the recesses 61 and 63 in the ends of the knuckles. In addition, the guide hinge 331 includes anti-rotation collars 456 and 476, corresponding to the anti-rotation collar 156 of guide hinge 31, at opposite ends of the non-headed hinge pin.

In a further embellishment, the hinge set can be configured as a non-handed hinge for use in both left-handed and right-handed door installations when hung from a jamb. Referring to FIG. 22, there is shown an exploded view of a set hinge 330 for a non-handed hinge set. The set hinge 330 is generally similar to the set hinge 30 shown in FIG. 3, and accordingly, components of the set hinge 330 have been given the same reference numbers as like components of the set hinge 30. The set hinge 330 differs from set hinge 30 in that vertical height adjustment mechanisms, including vertical height adjustment screws 352 and 372 and anti-rotation collars 356 and 376, are provided at opposite ends of a non-headed hinge pin 340. In addition, the set hinge 330 includes finials 359 and 379 and O-rings 361 and 381 corresponding to those of the set hinge shown in FIG. 21. Alternatively, the non-handed set hinge can be configured to be non-adjustable.

More specifically, referring to FIG. 22, the vertical height adjustment screw 352 and the anti-rotation collar 356 are arranged in the manner of the vertical height adjustment screw 52 and the anti-rotation collar 56 of set hinge 30 (FIGS. 2-5) The vertical height adjustment screw 352 is received in the lowermost knuckle 347 of the frame mounting plate 334. The vertical height adjustment screw 352 has a threaded outer surface 355 that engages a mating threaded inner surface of the knuckle 347. The upper end of the vertical height adjustment screw 52 includes a cylindrical aperture 353 which receives the bottom end of the hinge pin 340. The lower end of the vertical height adjustment screw 352 has a recess (not shown), which can be hexagonal in shape or some other shape suitable for receiving a tool, such as a hex wrench, screw driver, torque-drive, etc., for turning the vertical height adjustment screw 352 to raise and lower the adjustable hinge plate assembly 36, including the adjustment plate 70 and the housing assembly 89, relative to the frame mounting plate 334, providing vertical height adjustment for the door 20.

As shown in FIG. 22, the anti-rotation collar 356 is mounted in a portion of the cylindrical opening 348 formed by the lowermost knuckle 347 of the frame mounting plate 334. The anti-rotation collar 356 includes one or more wings or projections 358 that are received in grooves or slots 360 formed on the interior wall of the knuckle 347. The anti-rotation collar 356 prevents the vertical height adjustment screw 352 from turning as the door 20 is opened and closed.

The anti-rotation collar 356 is interposed between the upper end of the vertical height adjustment screw 352 and the lower end of the knuckle 81 of the adjustment plate 70 as shown in FIG. 23. Accordingly, as the vertical height adjustment screw 352 is turned in one direction, the anti-rotation collar 356 is moved vertically upward, moving the adjustment plate 70 upwardly, thereby adjusting the vertical position of the door 20 relative to the door frame 22. Turning the vertical height adjustment screw 352 in the opposite direction allows the anti-rotation collar 356 and the adjustment plate 70 to be moved vertically downwardly aided by the weight of the door.

The other vertical height adjustment screw 372 and the other anti-rotation collar 376 are mounted to the frame mounting plate 334 in a similar manner at the opposite end of the hinge pin 340. The upper end of the vertical height adjustment screw 372 (as oriented in FIG. 22) includes a recess 374, which can be hexagonal in shape or some other shape suitable for receiving a tool, such as a hex wrench, screw driver, torque-drive, etc., for turning the vertical height adjustment screw 372 to raise and lower the adjustable hinge plate assembly 36 relative to the frame mounting plate 334. The lower end vertical height adjustment screw 372 (as oriented in FIG. 22) includes a cylindrical aperture (not shown), corresponding to aperture 353 in the vertical height adjustment screw 752, which receives the top end of the hinge pin 340. The guide hinges 32 can be modified to include finials corresponding to the finials 359 and 379.

FIG. 23 is a view similar to that of FIG. 18 and showing the set hinge oriented for mounting a door in a first-handed installation and with the set hinge adjustable hinge plate assembly of the set hinge of FIG. 22 adjusted to a position that causes the door to be raised from a centered position.

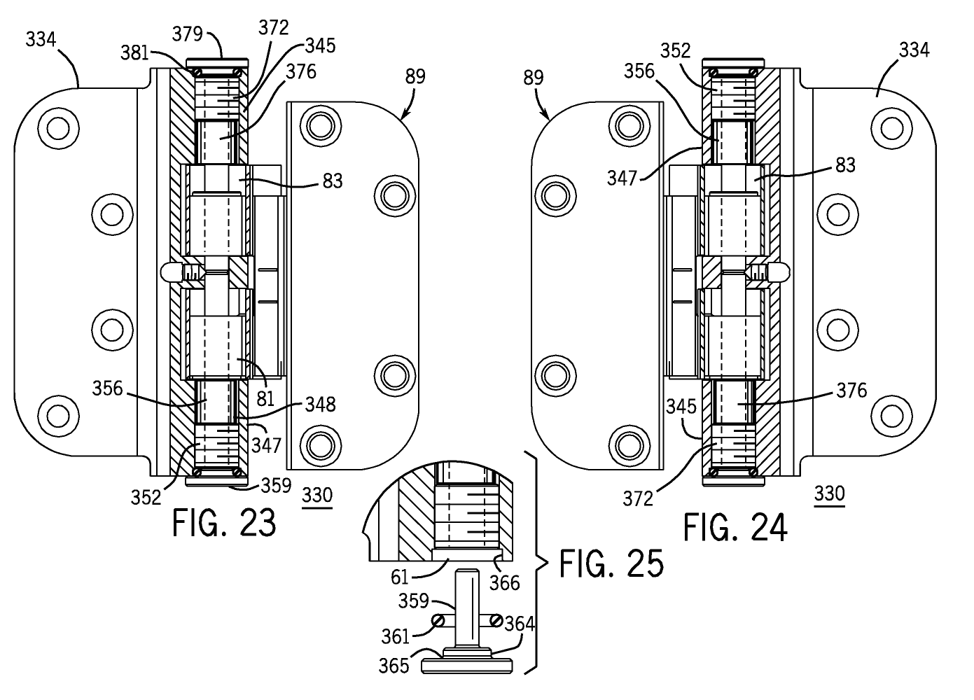

FIG. 24 is a view similar to that of FIG. 23 and with the set hinge rotated 180° to be oriented for mounting the door in the opposite-handed installation, and with the set hinge adjustable hinge plate assembly of the set hinge adjusted to a position that causes the door to be lowered from a centered position.

With the orientation shown in FIGS. 22 and 23, for providing the desired one of a left-handed or a right-handed installation of the door, the vertical height adjustment screw 352 of the set hinge can be used to adjust the vertical height of the door in the manner described above with reference to FIGS. 17-18. If the opposite installation of the door is desirable, the set hinge is inverted by rotating the set hinge 180° to the orientation illustrated in FIG. 23, and the vertical height adjustment screw 372 of the set hinge can be used to adjust the vertical height of the door. The clearance between the adjustment plate 70 and the knuckles on the frame mounting plate 334 allows for vertical adjustment in the position of the door. The adjustment plate 70 can be moved up or down with respect to the frame mounting plate 334, thereby moving the door vertically up or down. Because the guide hinges 31 and 32 do not include vertical adjustment screws, the adjustment plates 170 of the guide hinges 31 and 32 (FIG. 7) can move freely up or down relative to the frame mounting plates 134 as the adjustment plate 70 is moved up or down as has been described. In accordance with the present invention, the guide hinges 31 and 32 and the set hinge 330 allow vertical adjustment in the position of the door using to be made without affecting the horizontal position to which the door has been previously set.

Thus, it can be seen that the present invention provides a hinge set including a set hinge and one or more guide hinges. The hinge set enables independent adjustment of the position of the door relative to the frame in both vertical and horizontal directions. The set hinge is adjustable vertically, in a direction that is parallel to the door pivot axis, providing vertical adjustment in the position of the door. The guide hinges are adjustable horizontally in a direction that is transverse to the door pivot axis, providing horizontal adjustment in the position of the door. The pivot is fixed to the housing and is located spaced apart from the horizontal adjustment screw so that as a horizontal adjustment is being made, the door is moved outwardly horizontally from an initial position to an adjusted position. Moreover, the components of the guide hinges are identical with the components of the set hinge, except that the guide hinges and the set hinge differ in that they include different threaded adjustment components. This results in a significant reduction in manufacturing and assembly costs for the hinge set as well as in the cost for parts inventory.

Although the foregoing description of the present invention has been shown and described with reference to particular embodiments and applications thereof, it has been presented for purposes of illustration and description and is not intended to be exhaustive or to limit the invention to the particular embodiments and applications disclosed. It will be apparent to those having ordinary skill in the art that a number of changes, modifications, variations, or alterations to the invention as described herein may be made, none of which depart from the spirit or scope of the present invention. The particular embodiments and applications were chosen and described to provide the best illustration of the principles of the invention and its practical application to thereby enable one of ordinary skill in the art to utilize the invention in various embodiments and with various modifications as are suited to the particular use contemplated. All such changes, modifications, variations, and alterations should therefore be seen as being within the scope of the present invention as determined by the appended claims when interpreted in accordance with the breadth to which they are fairly, legally, and equitably entitled.

What is claimed is:

1. An adjustable hinge for pivotally mounting a door on a door frame for pivoting of the door about a pivot axis relative to the frame, said adjustable hinge configured for use in both left-handed and right-handed installations, said adjustable hinge comprising:
a mounting member adapted to be secured to the door frame;
an adjustable hinge assembly adapted to be secured to the door; and
a hinge pin coupling together said adjustable hinge assembly and said mounting member, allowing pivoting of the door relative to the door frame about a pivot axis;
said adjustable hinge assembly including a vertical adjustment mechanism adjustable to reposition the door vertically, wherein said vertical adjustment mechanism includes a first adjustment mechanism for providing vertical height adjustment in a left-handed installation and a second adjustment mechanism for providing vertical height adjustment in a right-handed installation.

2. The adjustable hinge according to claim 1, wherein said first adjustment mechanism includes a first adjustment element movably mounted near a first end of said hinge pin, and said second adjustment mechanism includes a second adjustment element movably mounted near a second end of said hinge pin.

3. The adjustable hinge according to claim 2, wherein said first and second adjustment elements comprise first and second threaded adjustment members located at opposite ends of said hinge pin.

4. The adjustable hinge according to claim 3, wherein said first and second threaded adjustment members extend coaxially with said hinge pin.

5. The adjustable hinge according to claim 2, wherein each of said adjustment mechanisms further includes an anti-rotation device mounted coaxially with said adjustment element to prevent said adjustment element from rotating as the door is pivoted about said vertical axis.

6. An adjustable hinge for pivotally mounting a door on a door frame for pivoting of the door about a pivot axis relative to the frame, said adjustable hinge configured for use in both left-handed and right-handed installations, said adjustable hinge comprising:
a mounting member adapted to be secured to the door frame;
an adjustable hinge assembly adapted to be secured to the door, said hinge assembly including an adjustment member; and
a hinge pin coupling together said adjustable hinge assembly and said mounting member, allowing pivoting of the door relative to the door frame about a pivot axis;
said adjustable hinge assembly further including a vertical adjustment mechanism coupled to said adjustment member, said vertical adjustment mechanism being adjustable to reposition said adjustment member vertically relative to said mounting plate, thereby repositioning the door vertically, wherein said vertical adjustment mechanism includes a first adjustment mechanism for providing vertical height adjustment in a left-handed installation and a second adjustment mechanism for providing vertical height adjustment in a right-handed installation.

7. The adjustable hinge according to claim 6, wherein said first adjustment mechanism includes a first adjustment element movably mounted near a first end of said hinge pin, and said second adjustment includes a second adjustment element movably mounted near a second end of said hinge pin.

8. The adjustable hinge according to claim 7, wherein said first and second adjustment elements comprise first and second threaded elements located at opposite ends of said hinge pin.

9. The adjustable hinge according to claim 8, wherein said first and second threaded elements are elongated elements extending coaxially with said hinge pin.

10. The adjustable hinge according to claim 7, wherein each of said adjustment mechanisms further includes an anti-rotation device interposed between said adjustment member and said adjustment element, said anti-rotation device being indexed to said mounting plate to prevent said adjustment element from rotating as said door is pivoted about said vertical axis.

11. The adjustable hinge according to claim 6, wherein said hinge pin is a non-headed pin.

12. An adjustable hinge for pivotally mounting a door on a door frame for pivoting of the door about a pivot axis relative to the frame, said adjustable hinge configured for use in both left-handed and right-handed installations, said adjustable hinge comprising:
a mounting plate adapted to be secured to the door frame, said mounting plate including at least a first hinge sleeve;
an adjustable hinge assembly adapted to be secured to the door, said hinge assembly including an adjustment member including at least a second hinge sleeve; and
a hinge pin extending through said first and second hinge sleeves, coupling together said hinge assembly and said mounting plate, allowing pivoting of the door relative to the door frame about a pivot axis;
said hinge assembly further including a vertical height adjustment mechanism including a first adjustment mechanism for providing vertical height adjustment in a left-handed installation and a second adjustment mechanism for providing vertical height adjustment in a right-handed installation, said adjustment mechanisms each including an adjustment screw adapted to be coupled to said adjustment member, the position of said adjustment screws being adjustable vertically along said vertical axis to reposition said adjustment member vertically relative to said mounting plate, thereby repositioning the door vertically vertically.

13. The adjustable hinge set according to claim 12, wherein said adjustment screw of said first adjustment mechanism is located at one end of said hinge pin, and said adjustment screw of said second adjustment is located at the opposite end of said hinge pin.

14. The adjustable hinge set according to claim 13, wherein said first and second adjustment screws extend coaxially with said hinge pin.

15. The adjustable hinge according to claim 13, wherein said first adjustment mechanism further includes a first anti-rotation device received in said first hinge sleeve interposed between said first adjustment screw and a surface of said adjustment member, and said second adjustment mechanism further includes a second anti-rotation device received in said first hinge sleeve interposed between said second adjustment screw and a surface of said adjustment member, said anti-rotation devices being indexed to said mounting plate to prevent said adjustment screws from rotating as said door is pivoted about said vertical axis.

16. The adjustable hinge according to claim 12, wherein said hinge pin is a non-headed pin having an axial opening at first and second opposite ends, and further including a first finial having a shank portion extending into said first axial opening and a head portion coupled to a surface of said mounting plate, and a second finial having a shank portion extending into said second axial opening and a head portion coupled to a surface of said mounting plate.

17. An adjustable hinge for pivotally mounting a door on a stationary frame for pivoting of the door about a pivot axis relative to the frame, said adjustable hinge comprising:
a mounting member adapted to be secured to one of the door and the door frame;
an adjustable hinge assembly adapted to be secured to the other one of the door and the door frame;
a hinge pin coupling together said hinge assembly and said mounting member, allowing pivoting of the door relative to the door frame about a pivot axis, said hinge pin having an axial opening at first and second opposite ends;
a first finial having a shank portion extending into said first axial opening and a head portion coupled to a first surface of said mounting member; and a second finial having a shank portion extending into said second axial opening and a head portion coupled to a second surface of said mounting member, said first and second finials being held in place by a friction fit.

18. The adjustable hinge according to claim 17, and including a first O-ring interposed between said head portion of said first finial and said first surface of said mounting member, and a second O-ring interposed between said head portion of said second finial and said second surface of said mounting member, enhancing the friction fit for the finials.

19. The adjustable hinge according to claim 18, wherein said head portion of said first finial includes a first annular groove receiving a portion of said first O-ring and said head portion of said second finial includes a second annular groove receiving a portion of said second O-ring.

20. The adjustable hinge according to claim 18, wherein said first O-ring is trapped between an inner surface of said first groove and said first surface of said mounting plate and said second O-ring is trapped between an inner surface of said second groove and said second surface of said mounting plate.
